(19) United States
(12) Patent Application Publication
(10) Pub. No.: US 2004/0196377 A1
(43) Pub. Date: Oct. 7, 2004

(54) Data recording in communications system

(76) Inventors: Ari Tikka, Oulu (FI); Jukka Wallenius, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/829,424

(22) Filed: Apr. 22, 2004

Related U.S. Application Data
(63) Continuation of application No. PCT/FI02/00544, filed on Jun. 19, 2002.

(30) Foreign Application Priority Data
Oct. 24, 2001 (FI) 20012061

(51) Int. Cl. G09G 5/02

(52) U.S. Cl. 348/207.1

(57) ABSTRACT

A method for recording data in a communications system and a communications system comprising at least one wireless terminal (UE), a video camera (CAM) coupled to the wireless terminal for providing the wireless terminal with a continuous data stream comprising at least video data, a communications network (1) with a wireless access network (RAN) and data storage means (MEM1, MEM2) connected to the communications network (1), whereby the wireless terminal (UE) is arranged to forward the data stream substantially instantly to the communications network (1) wirelessly via said wireless access network (RAN), and the communications system is arranged to store the data stream forwarded to the communications network in the data storage means connected to the communications network.

### FIELD OF THE INVENTION

This application is a Continuation of International Application PCT/FI02/00544 filed Jun. 19, 2002 which designated the U.S. and was published under PCT Article 21(2) in English.

The invention relates to recording data in a communications system, and particularly to recording continuous stream of data comprising at least video data in a communications system.

### BACKGROUND OF THE INVENTION

A typical prior art video data recording system is a video camcorder (camera-recorder) unit, which comprises a video camera, such as a CCD camera, which converts images into electric signals, i.e. video data, and a recorder, which is typically some kind of a mass memory device for storing the video data. The mass memory of a video camcorder can be a cassette tape memory, such as a DVC (Digital Video Cassette), a disc memory, such as a DVD (Digital Versatile Disc), or a memory card, for example.

One of the disadvantages associated with such prior art video camcorder units is that the mass memory mechanism typically increases the size and weight of the camcorder unit and makes it more complex and thus potentially more unreliable. Furthermore, the actual memory used in the mass memory device, such as a memory cassette or a disc, has a certain limited storage capacity and therefore has to be changed frequently when long recordings are made. A user of the video camcorder unit may thus have to carry several pieces of memory with him or her, and there is still the possibility that the memory runs out. The memory can also be rather expensive, which can be a major disadvantage especially if a lot of memory is needed.

The wide variety of different memory formats used also causes problems when the stored video data is to be seen or edited, for example, as the equipment used for viewing or editing the video data must be compatible with the particular memory format in order to be able to read the data. A special adapter is typically needed if a prior art video camcorder unit is to be connected to a personal computer system, for example.

### BRIEF DESCRIPTION OF THE INVENTION

An object of the present invention is thus to provide a method and an apparatus for implementing the method so as to overcome the above problems or at least to alleviate them. The objects of the invention are achieved by a method, a communications system and a wireless terminal which are characterized by what is stated in the independent claims 1, 14 and 31. Preferred embodiments of the invention are disclosed in the dependent claims.

The invention is based on the idea of coupling a wireless terminal to a video camera and transmitting a continuous data stream comprising at least video data produced by the video camera substantially instantly from the wireless terminal to a communications network wirelessly, whereby the data stream can be stored in the network in a memory connected to the network.

An advantage provided by the invention is that no mass memory is needed in the video camera as the data can be stored in a separate memory connected to the communications network. The stored data can be easily managed in the network, and it is also possible to edit the data by using a personal computer connected to the network, for example. Furthermore, the format of the data can be easily changed from one to another and the data can be easily further forwarded from the network. The invention also enables a simpler camera structure and a larger and more economical memory capacity.

### BRIEF DESCRIPTION OF THE DRAWINGS

In the following the invention will be described in greater detail by means of the preferred embodiments and with reference to the accompanying drawings, in which

FIG. 1 is a block diagram illustrating a communications system according to an embodiment of the invention;

FIG. 2 is a block diagram illustrating a camera/wireless terminal according to an embodiment of the invention;

FIG. 3 is a block diagram illustrating the connection of a user terminal and a memory according to an embodiment of the invention;

FIG. 4 is diagram illustrating timeline presentation of data according to an embodiment of the invention;

FIG. 5 is a signaling diagram illustrating timeline-based editing of video data according to an embodiment of the invention; and

FIG. 6 is a signaling diagram illustrating a procedure for starting playing of the video data.

### DETAILED DESCRIPTION OF THE INVENTION

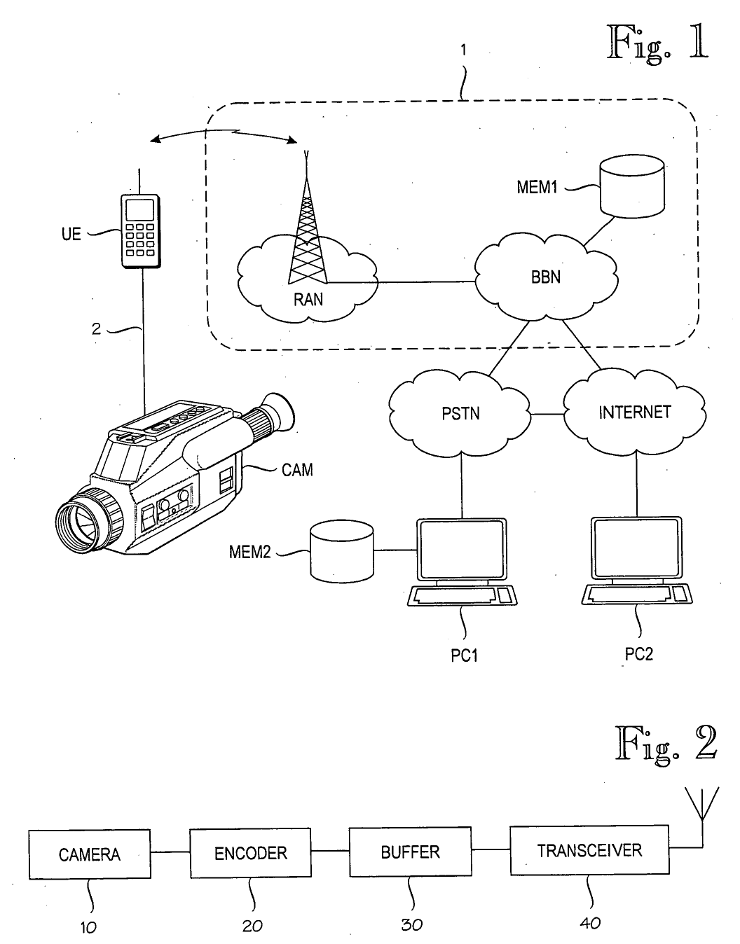

FIG. 1 is a simplified block diagram showing the most important parts of a communications system in which the present invention can be implemented without, however, restricting the invention to the system shown. The detailed structure and functions of the system elements are not shown in detail, because they are considered obvious to a person skilled in the art.

The system of FIG. 1 comprises a communications network 1. The main parts of the network 1 are a backbone network BBN, such as an IP network (the Internet or an intranet, for example) or an optical network, and a radio access network RAN, such as a cellular network or a wireless local area network. An example of such a communications network 1 is the third-generation UMTS (Universal Mobile Telecommunications System), in which the radio access network RAN is implemented by wideband code division multiple access (WCDMA) technology, for example. The communications system also comprises user equipment UE, which is also known as a subscriber terminal or a mobile station, for instance, and which can communicate with the communications network 1 via an air interface provided by the radio access network RAN. The backbone network BBN comprises the fixed infrastructure of the network 1, connecting the network 1 to other networks, such as a public switched telephone network PSTN and the Internet, as illustrated. There can be more than one radio access network RAN connected to the backbone network BBN such that they provide different types of air interfaces to the communications network 1. It should be noted that the invention can be implemented in various wireless communications systems and it is not restricted to any particular network type, for example. The division of the communications network 1 into the radio access network RAN and backbone network BBN is not necessarily a strict one. This, however, is irrelevant to the basic idea of the invention. Besides the already mentioned UMTS/WCDMA, other possible wireless communications networks providing wireless access that can be utilized include GSM (Global System for Mobile Communications), GPRS (General Packet Radio System), EDGE, which is a GSM-based radio system employing EDGE (Enhanced Data Rates for Global Evolution) technology for increasing the data transmission rate, wireless IP network, Bluetooth or WLAN (Wireless Local Area Network). Any combination of these or other systems can also be used. A person skilled in the art can also apply the instructions to other wireless systems containing corresponding characteristics.

FIG. 1 further illustrates a video camera CAM connected to the user equipment UE. A connection 2 between the camera CAM and the user equipment UE can be a wired connection or a wireless connection, such as an infrared link or Bluetooth. Furthermore, the camera CAM and the user equipment UE can be separate units, as illustrated, or one physical entity, i.e. the user equipment UE comprises the video camera CAM enclosed in its housing. The connection 2 between the camera unit CAM and the user equipment UE are arranged to transfer at least the video data produced by the video camera CAM to the user equipment UE when the camera CAM is shooting. The connection 2 can also be arranged to transfer audio and/or some other data from the user equipment UE to the camera CAM. According to the invention, the communications system also comprises some kind of storage means, i.e. a memory for storing data and connected to the communications network 1. FIG. 1 shows two exemplary ways of connecting the memory to the communications network 1. A memory MEM1 is directly connected to the backbone network BBN. The memory MEM1 can be a separate element or a part of some other network element. The memory MEM1 can also be physically divided into two or more parts and logically seen as one unit. A memory MEM2, in turn, is connected to the communications network 1 via a personal computer PC1, which has a connection to the communications network 1 via the PSTN. The connection between the PC1 and the PSTN can be an ADSL (Asymmetric Digital Subscriber Line), for example, which typically supports downstream data rate of 1.5 to 8 Mbit/s and thus enables the transmission of continuous stream of video data, such as live video data, at an adequate speed. Numerous other ways of connecting a memory to the communications network 1 are also possible without deviating from the basic idea of the invention. The memory MEM1 or MEM2 for storing the data can be practically any type of a mass memory suitable for storing a continuous stream of data comprising video data. The memory MEM1 or MEM2 can be an optical or a magnetic memory using a tape or a disc, such as a DVD (Digital Versatile Disc) or a hard disc, or it can be a semiconductor memory, such as a memory circuit, for example. The invention is not restricted to any particular type of memory. The number of the memory units MEM1 and MEM2 used in the system is not limited either. If the memory MEM1 or MEM2 used for storing the data stream is shared by several users, the stored data is preferably provided with a suitable code, for example, such that the owner of a particular piece of data can be identified later.

According to the invention, when the user starts to shoot with the camera CAM and the user equipment UE starts receiving a continuous data stream from the camera, this data stream is forwarded to the communications network 1 via the air interface between the user equipment and the radio access network RAN. The data stream is forwarded substantially instantly such that there is no need to store a large amount of data in the camera CAM or in the user equipment UE. The data stream received in the communications network 1 is then stored in one or more of the memories MEM1 and MEM2 connected to the network 1. If, for example, the memory MEM1 is used, the data stream can be directly transferred to the MEM1 within the network 1 and stored therein. If the memory MEM2 is used for storing, the data stream is transferred from the communications network 1 via the PSTN to the personal computer PC1 and stored to the memory MEM2 connected to the computer PC1. The data stream is forwarded and stored substantially continuously as long as the camera CAM produces a data stream, i.e. as long as the user shoots with the camera.

FIG. 2 shows a more detailed block diagram of the basic structure of the camera/user equipment. The camera CAM comprises a basic camera block 10, comprising at least the basic camera functions. The basic camera block 10 comprises a device capable of producing at least a video signal and the necessary electronics, such as a control unit, connected thereto. The basic camera block 10 can be based on a CCD (Charge Coupled Device) or a CMOS (Complementary Metal Oxide Semiconductor) camera module capable of producing a continuous stream of video data, i.e. motion video data. Such camera modules are well known in the art and readily available. Also other types of basic camera structures can be used. The term “motion video” generally refers to a stream of successive video images or frames, which produce an impression of a moving image. The required frequency of the video frames (described in frames-per-second or fps) depends on the particular video material. Higher frame rates improve the appearance of video motion. A so-called full-motion video typically refers to a frame rate of 30 fps or more. The invention, however, is not limited to any particular frame rate. The camera block 10 can also be capable of producing an audio signal whereby the data stream provided by the camera block 10 can also comprise audio data. Furthermore, the camera block can comprise control functions for controlling the storing of the data stream in the network 1. The possible control signals from the camera block 10 can be transmitted to the user equipment UE and/or the network 1 by adding control data to the data stream produced by the camera block 10. The basic camera block 10 can further comprise various image processing functions implemented by a digital signal processor (DSP), for example. The video and other data produced by the basic camera block 10 are preferably in a digital format. The particular data format or the resolution of the video frames contained in the data stream is irrelevant to the basic idea of the invention, and depend on the particular system the invention is applied to.

The data stream produced by the camera block 10 is preferably compressed prior to sending it over the air interface between the user equipment UE and radio access network RAN. The data stream is compressed in an encoder block 20. If the camera CAM and the user equipment UE are separate devices, the encoder block 20 can reside in either of these devices. It is also possible that both the camera CAM and the user equipment UE comprise encoder blocks of their own. The data stream can be compressed by using any known or future compression method. Suitable compression methods include any MPEG (Moving Picture Experts Group) format, such as MPEG4, or a RealVideo format, such as RealVideo version 8.0. The ratio of the compression is preferably arranged to be selectable by the user of the camera CAM and user equipment UE within the limits set by the connection between the camera/user equipment and the memory MEM1 or MEM2. Typically, the air interface between the user equipment UE and the radio access network RAN sets this limit. For example, a WCDMA air interface can typically provide a data speed of 128 kbit/s to 2 Mbit/s. If the original data speed of the data stream produced by the camera block 10 is 10 Mbit/s, the data speed can be reduced to approximately 128 kbit/s by using a compression ratio of 1:80, for example. The compression ratio also affects the quality of the video data and possible audio data contained in the data stream, and the compression ratio used should preferably be selected on the basis of the required data quality and the data transfer speed provided by the air interface between the user equipment UE and the radio access network RAN. The invention, however, is by no means limited to any specific data compression method or compression ratio.

In order to enable transmission error correction, the compressed data stream produced by the encoder block 20 is then preferably buffered prior sending it from the user equipment UE. The connection between the user equipment UE and radio access network RAN may occasionally break, and some of the data may have to be resent and the connection may have to be reestablished. The size of a data buffer 30 to be used can be selected on the basis of the reliability of the particular access system used. If the data speed of the data stream to be buffered is 128 kbit/s, for example, and a 30-second buffering time is desired, the required buffer size is approximately 4 Mbit. The buffer block 30 is preferably located in the user equipment UE. Finally, after the buffer 30, the data stream is sent to the radio access network RAN by the transceiver block 40 of the user equipment UE and stored in the memory MEM1 or MEM2 as described earlier.

If the video data is stored in the memory MEM2, the user can readily have access to the data via the computer PC1 and view and edit the data, for example. If a memory residing in the network 1, like the memory MEM1, is used for storing the video data, the user can access the data from the computer PC1 via the PSTN or from the computer PC2 connected to the network 1 via the Internet. Also any other terminal equipment connected to the network 1 can be used for accessing the stored data. The video data stored in memory MEM1 can then be edited or downloaded to the PC1 or PC2, for example. The communications network 1 preferably comprises a suitable user interface via which the memory MEM1 can be accessed and which enables editing and downloading the data and other similar functions. If the data is stored in a compressed format, it is preferably decompressed before being used. The decompression can take place in the terminal equipment PC1 or PC2 from which the data is accessed, for example. The user can also send the video data from the memory MEM1 or MEM2 to other parties via the Internet, for example. The stored data can also be used in numerous other ways considered obvious to a person skilled in the art.

The camera unit CAM and/or the user equipment UE comprises suitable control means for controlling at least the basic functions necessary to operate the camera, such as start and stop recording functions. If the camera unit CAM and the user equipment UE are physically separate devices, either of these devices can comprise said control means. The camera unit CAM and/or the user equipment UE may further comprise more advanced functions, such as viewing and editing the video data recorded in the memory MEM1 or MEM2. This can be accomplished by providing the camera unit CAM and/or the user equipment UE with a suitable display unit and means for receiving the data from the memory MEM1 or MEM2. Such means for receiving the data comprise at least the transceiver unit 40 of the user equipment UE and a decoder unit if the data is received in a compressed format and needs to be decompressed. Thanks to the present invention, no mass memory is needed in the camera unit CAM. However, the camera unit CAM may comprise a mass memory for example for backup purposes since the wireless connection between the camera/user equipment and the communications network 1 may not always be available.

According to an embodiment of the invention, a direct user interface is provided for a user terminal UE, PC1 or PC2 for editing the video data in the memory MEM1 or MEM2. The user terminal can be a wireless terminal, e.g. user equipment UE in FIG. 1, or a wired terminal such as the computer PC1 or PC2. The user interface enables the video data in the memory MEM1 or MEM2 to be accessed and edited or processed in some other way from the user terminal without the need to download all the video data to the user terminal. In other words, the video data can be edited in the memory MEM1 or MEM2 without the need to transfer it to another location for editing; only small portions of the video data, such as a sample still picture or pictures, are transferred to the user terminal during the editing. After the video data has been edited, it can be delivered to a desired destination such as another subscriber, for example. An advantage of this embodiment of the invention is that it provides for e.g. deletion of certain parts of the video data prior to delivery of the video data to the recipient. The delivery can be a one-way call to the adressee. The delivery can use an approach based on a web form, such as a HTML form, as well, where the addressee is just informed of the presentation and the adressee can then setup the session to the caller. The charging can be reversed in this case so that the caller pays for a fixed number of viewing sessions. The video stream preferably uses a coding, which allows frame numbering. These frame numbers are indicated to the editing server to indicate correct frames. WSP (Wireless Session Protocol) or HTTP (HyperText Transfer Protocol) and webforms can be used to provide title texts and greetings. An example of the implementation of the editing procedure is given in the following.

The video data editing is preferably based on a connection to the memory 70 (corresponding e.g. to MEM1 or MEM2 in FIG. 1) via a WWW (World Wide Web) or WAP (Wireless Application Protocol) server 60, for example, as shown in FIG. 3. The memory 70 is thus preferably connected to a communications network 1 (not shown in FIG. 3) via the server 60. The WWW or WAP server 60 can be included in the communications network 1 or it can be connected thereto, e.g. directly or via the Internet. Furthermore, the server 60 can be a separate network element or a part of some other network element or integrated into the memory 70. This, however, has no particular relevance to the basic idea of the invention. Thus, the user terminal 50 (e.g. UE, PC1 or PC2 in FIG. 1) can preferably access the video data in the memory 70 by connecting to the server 60 connected to the memory. The user interface functions provided to the user terminal 50 can be implemented e.g. by suitable software in one or several system elements such as the server 60 and/or the memory 70. The memory 70 preferably comprises suitable control means (not shown separately in the figures) for enabling the use of the memory.

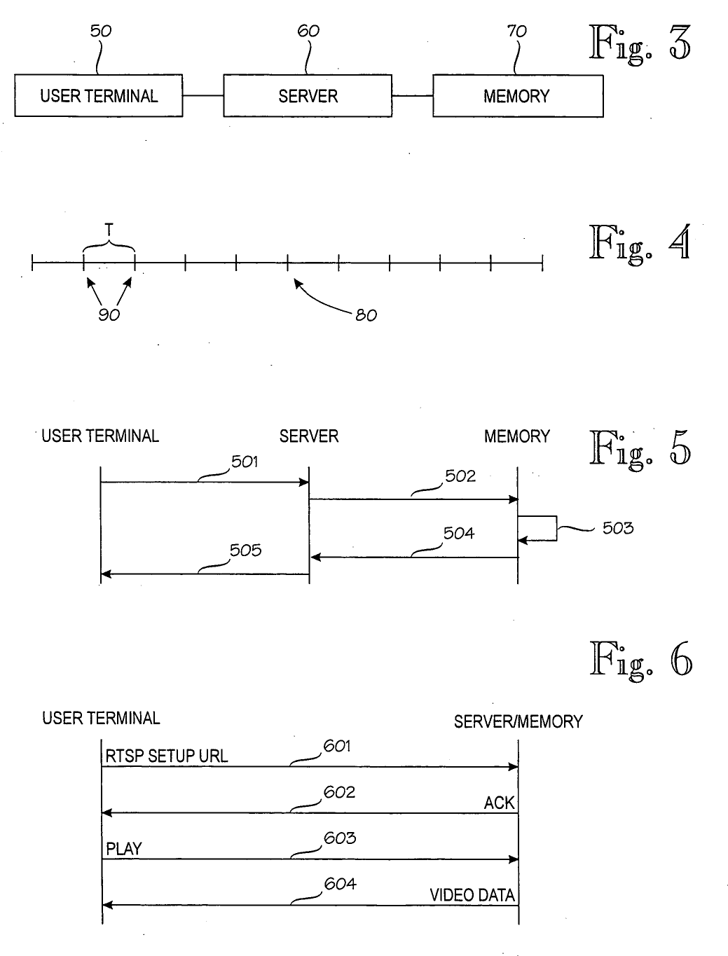

The user interface provided to the user of the user terminal 50 can be based on representing the video data in the memory 70 as a timeline 80 divided into sections by stages 90 such that the stages appear at intervals T of e.g. 10 seconds as shown in FIG. 4. In FIG. 4, the timeline 80 is divided into 10 stages 90. The number of the stages and the length of the time section T can be selected according to system and/or user preferences. The length of the time section T can also vary between consecutive stages. The user terminal is then provided upon request with a still picture(s) corresponding to one or more of such stages 90. Still pictures of all the stages 90 are preferably provided to the user terminal and shown to the user of the user terminal 50 in a table format, for example. The user can then select to view the video data starting from a desired stage 90 and preferably ending to another stage 90. Furthermore, the video data can be edited by deleting a certain part of the timeline e.g. by giving the corresponding start and end stages 90 of the part to be deleted. In a similar manner, parts of the video data can be moved to folders provided by the user interface or processed in a number of other ways considered obvious to a person skilled in the art.

According to an embodiment of the invention, the timeline 80 and particularly the stages 90 of the timeline comprise a link to a video presentation consisting of the video data starting from the stage 90 in question. When a stage is selected, e.g. for viewing of the video data, from the user terminal 50, a terminating video call is formed to the user terminal 50, preferably by using session initiation protocol (SIP). SIP is an application-layer control protocol for creating, modifying and terminating sessions with one or more participants. The sessions can include Internet multimedia conferences, Internet telephone calls and multimedia distribution. Members in a session can communicate via multicast or via a mesh of unicast relations, or a combination of these. Another alternative, when a stage is selected, is to provide the user of the user terminal 50 with a link to an RTSP (Real Time Streaming Protocol) stream sent to the user terminal. RTSP is an application-level protocol for the delivery of real-time data, which establishes and controls either one or several time-synchronised streams of continuous media. RTSP provides an extensible framework to enable controlled, on-demand delivery of audio and video data. Sources of data can include both live data feeds and stored clips. A link corresponding to a certain stage 90 of the timeline 80 starts the video data stream from the stage in question. The link to the RTSP stream sent to the user terminal 50 preferably comprises a time stamp corresponding to the selected stage, the timestamp being used in forming the RTSP session. The user interface preferably comprises a script that can separate the timestamp in the link and deliver it to the user terminal 50 to be used in the RTSP PLAY operation sent to the network.

FIG. 5 is a signaling diagram illustrating the timeline-based editing of the video data according to an embodiment of the invention. First the user terminal 50 requests 501 from the server 60 one or more still pictures corresponding to one or more stages 90. The server 60 sends a request 502 to the memory 70 requesting the still pictures. The requested still pictures, i.e. part of the video data stored in the memory 70, are preferably decoded 503 in the memory 70 and after that the decoded still pictures are sent 504 to the server 60. The server 60 sends 505 the still pictures and corresponding links with the time stamps (URL+T1, . . . URL+Tn), where T1 is the starting time in the timeline 80), to the user terminal 50 e.g. as a WWW page, whereby the links can appear in the WWW page as text links or image links, for example.

FIG. 6 is a signaling diagram illustrating the procedure for starting the playing of the video data from a desired stage 90. First the user terminal 50 sends an RTSP SETUP request 601 with the URL. The SETUP request causes the server (in FIG. 6 the server and the memory are shown as one entity) to allocate resources for a stream and start an RTSP session. Next the server acknowledges 602 the request. When the actual play of the video data is to be started from the selected stage, the user terminal sends 603 a corresponding PLAY request to the server. The PLAY request preferably comprises a time stamp corresponding to the selected stage. As a result, the video data stream 604 is delivered to the user terminal from the server/memory.

It will be obvious to a person skilled in the art that, as the technology advances, the inventive concept can be implemented in various ways. The invention and its embodiments are not limited to the examples described above but may vary within the scope of the claims.

1. A method for recording data in a communications system comprising at least one wireless terminal, a communications network with a wireless access network and data storage means connected to the communications network, the method comprising:
providing a wireless terminal with a continuous data stream comprising at least video data;
forwarding the data stream substantially instantly from the wireless terminal to the communications network wirelessly via said wireless access network;
storing the data stream in the data storage means connected to the communications network; and
viewing and/or editing of the stored data from a user terminal connected to the communications network, whereby the viewing and/or editing of the stored data comprises dividing the data into sections.

2. The method of claim 1, wherein the data stream further comprises audio data and/or control data.

3. The method of claim 1, wherein the forwarding of the data stream comprises compressing the data before it is transmitted over an air interface between the wireless terminal and the wireless access network.

4. The method of claim 3, wherein the data is compressed at least according to an MPEG compression format or a RealVideo compression format.

5. The method of claim 1, wherein the forwarding of the data stream comprises buffering the data in the wireless terminal before it is transmitted over the air interface between the wireless terminal and the wireless access network in order to enable transmission error correction.

6. The method of claim 1, wherein the viewing and/or editing of the stored data comprises providing a data sample of one or more sections for the user terminal connected to the communications network, whereby the viewing and/or editing of the stored data is performed on the basis of the data samples.

7. The method of claim 6, wherein the data sample of a section is a still picture.

8. The method of claim 6, wherein the user terminal is provided with one or more links corresponding to one or more sections of the stored data.

9. The method of claim 1, wherein the editing of the stored data comprises one or more of the following: deleting one or more of the sections, changing the order of the sections, copying one or more of the sections.

10. The method of claim 1, wherein the viewing and/or editing of the stored data is performed by using Real Time Streaming Protocol.

11. The method of claim 1, wherein the viewing and/or editing of the stored data is performed by using Session Initiation Protocol.

12. A communications system comprising:
at least one wireless terminal;
a video camera coupled to the wireless terminal for providing the wireless terminal with a continuous data stream comprising at least video data;
a communications network with a wireless access network; and
data storage means connected to the communications network;
wherein the wireless terminal is configured to forward the data stream substantially instantly to the communications network wirelessly via said wireless access network;
the communications system is configured to store the data stream forwarded to the communications network in the data storage means; and
the communications network comprises means for enabling the stored data stream to be viewed and/or edited by a user terminal connected to the communications network, whereby the communications system is configured to divide the stored data into sections for viewing and/or editing of the data.

13. The communications system of claim 12, wherein the data stream provided by the video camera further comprises audio data and/or control data.

14. The communications system of claim 12, wherein the wireless terminal comprises compressing means for compressing the data before it is transmitted over an air interface between the wireless terminal and access network.

15. The communications system of claim 14, wherein the compression means are arranged to compress the data according to at least an MPEG compression format or a RealVideo compression format.

16. The communications system of claim 12, wherein the wireless terminal comprises buffering means for buffering the data in the wireless terminal before it is transmitted over the air interface between the wireless terminal and access network in order to enable transmission error correction.

17. The communications system of claim 12, wherein the communications network comprises means for sending the stored data stream to a user terminal connected to the communications network.

18. The communications system of claim 12, wherein the communications system is configured to provide a data sample of one or more sections for the user terminal connected to the communications network and to view and/or edit the stored data on the basis of the data samples.

19. The communications system of claim 18, wherein the data sample of a section is a still picture.

20. The communications system of claim 18, wherein the communications system is configured to provide the user terminal with one or more links corresponding to one or more sections of the stored data.

21. The communications system of claim 12, wherein the editing of the stored data comprises one or more of the following: deleting one or more of the sections, changing the order of the sections, copying one or more of the sections.

22. The communications system of claim 12, wherein the communications system is configured to use Real Time Streaming Protocol for viewing and/or editing of the stored data.

23. The communications system of claim 12, wherein the communications system is configured to use Session Initiation Protocol for viewing and/or editing of the stored data.

24. The communications system of claim 12, wherein the communication system comprises a server for connecting the data storage means to the communications network.

25. The communications system of claim 12, wherein the wireless access network provides an air interface according to one or more of the following types: GSM, GPRS, EDGE, WCDMA, wireless IP, Bluetooth, WLAN.

26. The communications system of claim 12, wherein the data storage means comprises a mass memory device.

27. A wireless terminal of a communications system comprising a communications network with a wireless access network, the terminal comprising:
means for receiving a continuous data stream comprising at least video data from a video camera; and
means for forwarding the received data stream substantially instantly to the communications network wirelessly via said wireless access network for storage;
wherein the wireless terminal is configured to view and/or edit the stored data stream such that, when the stored data is divided into sections for viewing and/or editing of the data, the wireless terminal is configured to receive a data sample of one or more sections and to view and/or edit the stored data on the basis of the data samples.

28. The wireless terminal of claim 27, wherein the data stream further comprises audio data and/or control data.

29. The wireless terminal of claim 27, wherein the wireless terminal comprises compressing means for compressing the data before it is transmitted over an air interface between the wireless terminal and access network.

30. The wireless terminal of claim 29, wherein the compression means is configured to compress the data according to at least an MPEG compression format or a RealVideo compression format.

31. The wireless terminal of claim 27, wherein the wireless terminal comprises buffering means for buffering the data in the wireless terminal before it is transmitted over the air interface between the wireless terminal and access network in order to enable transmission error correction.

32. The wireless terminal of claim 27, wherein the wireless terminal comprises a video camera.

33. The wireless terminal of claim 27, wherein the wireless terminal comprises means for coupling the wireless terminal to an external video camera.

34. The wireless terminal of claim 27, wherein the wireless terminal is configured to use an air interface according to one or more of the following types: GSM, GPRS, EDGE, WCDMA, wireless IP, Bluetooth, WLAN.

35. The wireless terminal of claim 27, wherein the data sample of a section is a still picture.

36. The wireless terminal of claim 27, wherein the wireless terminal is configured to use Real Time Streaming Protocol for viewing and/or editing of the stored data.

37. The wireless terminal of claim 27, wherein the wireless terminal is configured to use Session Initiation Protocol for viewing and/or editing of the stored data.
